(19) United States
(12) Patent Application Publication
(10) Pub. No.: US 2022/0182283 A1
(43) Pub. Date: Jun. 9, 2022

(54) DYNAMIC OPTIMIZATIONS OF SERVER AND NETWORK LAYERS OF DATACENTER ENVIRONMENTS

(71) Applicant: Hewlett Packard Enterprise Development LP, Houston, TX (US)

(72) Inventors: David C. Fogaren, JR., Andover, MA (US); Gowdham Natanasabapathy, SanJose, CA (US)

(21) Appl. No.: 17/111,835

(22) Filed: Dec. 4, 2020

(51) Int. Cl. H04L 12/24; H04L 12/931

(52) U.S. Cl. CPC H04L 41/082; H04L 49/20

(57) ABSTRACT

Embodiments are directed to dynamic optimizations of server and network layers of datacenter environments. An embodiment of a storage medium includes instructions for operations including analyzing, by the hardware processor executing an infrastructure manager managing at least one server and a network fabric, packet information of one or more traffic data packets communicated by the at least one server over the network fabric, the packet information comprising at least one of a source port field, a destination port field, or an urgency field; identifying, based on analyzing the packet information, a workload running on the at least one server; causing server settings of the at least one server to be updated based on the identified workload; and causing network settings of the network fabric to be updated based on the identified workload.

### BACKGROUND

Data centers provide a pool of resources (e.g., computational, storage, network) that are interconnected via a communication network. In modern data center network architectures, a networking switch fabric typically serves as the core component that provides connectivity between the network resources, and facilitates the optimization of server to server (e.g., east-west) traffic in the data center. Such switching fabrics may be implemented using a software-defined transport fabric that interconnects a network of resources and hosts via a plurality of top of rack network (TOR) fabric switches.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 illustrates one embodiment of a system employing a data center.

FIG. 2 illustrates a data center environment including an infrastructure manager providing for dynamic optimizations of server and network layers according to some embodiments.

FIG. 3 is a block diagram of a data center environment implementing dynamic optimizations of server and network layers according to some embodiments.

FIG. 4 is an example packet header of a datacenter environment that is analyzed for dynamic optimizations of server and network layers according to some embodiments.

FIG. 5 illustrates operations for dynamic optimizations of server and network layers according to some embodiments.

FIG. 6 illustrates operations for another process for dynamic optimizations of server and network layers according to some embodiments.

### DETAILED DESCRIPTION

Embodiments described herein are directed to dynamic optimizations of server and network layers of datacenter environments. As customers include private cloud infrastructure as a part of their overall cloud strategy, the customers expect their infrastructure and applications to run optimally in private cloud environments similar to the public (often workload optimized) clouds. Currently, in modern composable and private cloud-based datacenter environments, servers and networks experience frequent changes to their settings in order to enable correct functioning of changing workloads running on the servers and networks.

Typically, network, server, and application administrators manually implement best practices for particular workloads running on the servers and networks based on reference architecture documents. This often results in unoptimized server and network settings configured for a workload in the datacenter environments, especially when the type of workload running on the servers and network is frequently changing. For example, network, server and application administrators may rely on a reference architecture (or several documents) and apply what the administrators think are the right best practices based on the particular environment in place and what can be controlled. In some examples this can result in the proper Basic Input/Output System (BIOS) settings not being configured for the server and/or network that the workload that is running on.

Implementations of the disclosure provide for dynamically optimizing server and network (e.g., layer 2 and layer 3 TCP/IP) fabric of a datacenter environment. An infrastructure manager is provided that can automatically and dynamically optimize the network and compute (e.g., compute server) infrastructures properly for workloads running over the infrastructures. The infrastructure manager can analyze traffic data running over the network fabric it manages in order to identify particular workloads running on the infrastructure. Once sufficient traffic data is analyzed, the infrastructure manager can identify the workload and cause one or more BIOS and/or network configuration settings to be optimized on both the server running the workload as well as the network fabric communicating the workload.

In one example, the system or process of implementations operates by a compute module (e.g., a server instance) receiving a packet. A network fabric component, such as a chassis/frame network switch, saves packet information of the received packet to a consolidated switch packet data file. An infrastructure manager retrieves the consolidated switch packet data file that includes packet header data of network packets communicated through the network fabric components managed by the infrastructure manager. The infrastructure manager analyzes the retrieved file and identifies a workload running on one or more compute modules (e.g., managed server instances) associated with the network packets based on, for example, source, destination, and/or urgency (e.g., Quality of Service (QoS)) fields in Transmission Control Protocol/Internet Protocol (TCP/IP) headers of the network packets.

Based on the identified workload, the infrastructure manager uses this data to cause the server and/or network to be programmed optimally for the identified workload. For example, the infrastructure manager implements recommendations and/or optimizations (e.g., updating BIOS setting) to its managed compute modules, such as the managed server instances. The infrastructure manager also implements recommendations to its managed network fabric components (e.g., chassis/frame and/or top of rack (ToR)/end of rack (EoR) switch setting updates).

Implementations of the disclosure provide a technical effect of achieving improved server and network fabric performance over conventional solutions by automatically optimizing servers and network settings for the particular workloads that are in place. This results in better performance of the servers and network fabric in terms of resource utilization, as well as improved latency and bandwidth of the server and network components. Furthermore, this result in improved troubleshooting of such components.

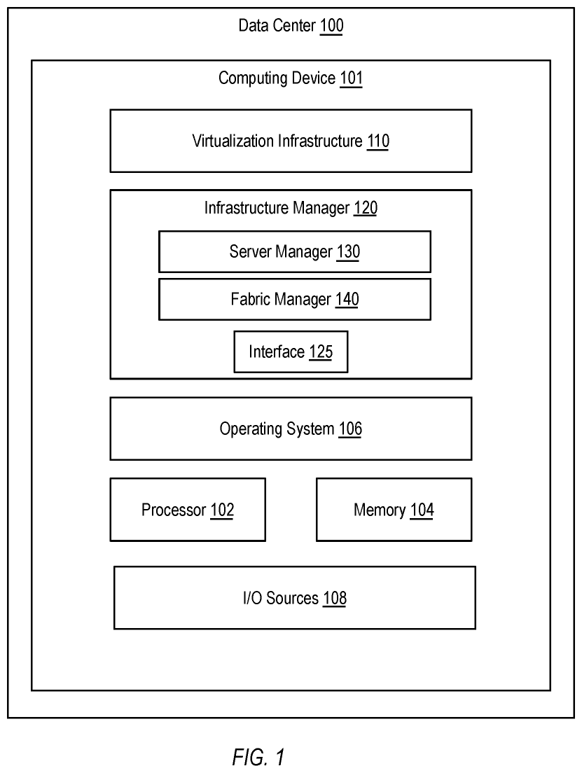

FIG. 1 illustrates one embodiment of a data center 100. As shown in FIG. 1, data center 100 includes one or more computing devices 101 that may be server computers serving as a host for data center 100. In embodiments, computing device 101 may include (without limitation) server computers (e.g., cloud server computers, etc.), desktop computers, cluster-based computers, set-top boxes (e.g., Internet-based cable television set-top boxes, etc.), etc. Computing device 101 includes an operating system (“OS”) 106 serving as an interface between one or more hardware/physical resources of computing device 101 and one or more client devices, not shown. Computing device 101 further includes processor(s) 102, memory 104, input/output (“I/O”) sources 108, such as touchscreens, touch panels, touch pads, virtual or regular keyboards, virtual or regular mice, etc.

In one embodiment, computing device 101 includes a server computer that may be further in communication with one or more databases or storage repositories, which may be located locally or remotely over one or more networks (e.g., cloud network, Internet, proximity network, intranet, Internet of Things (“IoT”), Cloud of Things (“CoT”), etc.). Computing device 101 may be in communication with any number and type of other computing devices via one or more networks.

According to one embodiment, computing device 101 implements a virtualization infrastructure 110 to provide virtualization for a plurality of host resources (or virtualization hosts) included within data center 100. In one embodiment, virtualization infrastructure 110 is implemented via a virtualized data center platform (including, e.g., a hypervisor). However other embodiments may implement different types of virtualized data center platforms. Computing device 101 also facilitates operation of a network switching fabric. In one embodiment, the network switching fabric is a software-defined transport fabric that provides connectivity between the hosts within virtualization infrastructure 110.

In one embodiment, the computing device 101 implements an infrastructure manager 120. Infrastructure manager 120 can communicate with and manage compute, storage, and fabric resources across a datacenter environment of data center 100. Infrastructure manager 120 may include an integrated, converged management platform that increases automation and streamlines processes across the managed compute, storage, and fabric resources of the datacenter environment. Infrastructure manager 120 may include an interface 125 to communicate with virtualization infrastructure 110, and enable a server manager 130 and a fabric manager 140 of infrastructure manager 120 to communicate with the compute, storage, and fabric resources of the datacenter environment.

Server manager 130 is configured to communicate with and manage server hosts, including virtualized and physical server hosts, in the datacenter environment. Fabric manager 140 is configured to communicate with and manage network fabric components of the data center environment. Such network fabric components may include chassis/frame switches and ToR/EoR switches, for example.

In implementations of the disclosure, the infrastructure manager 120 utilizes the server manager 130 and fabric manager 140 to dynamically optimize settings of server and network layers of the datacenter environments based on analysis of data traffic packets examined by the infrastructure manager 120. The analysis of the data traffic packets by the infrastructure manager 120 allows the infrastructure manager 120 to properly identify workloads running on the server components and/or communicated by the network fabric components. The identified workload is then utilized by the infrastructure manager 120 to cause the server manager 130 and/or fabric manager 140 to implement optimized settings of the server and network layers of the data center 100 to efficiently handle the identified workload.

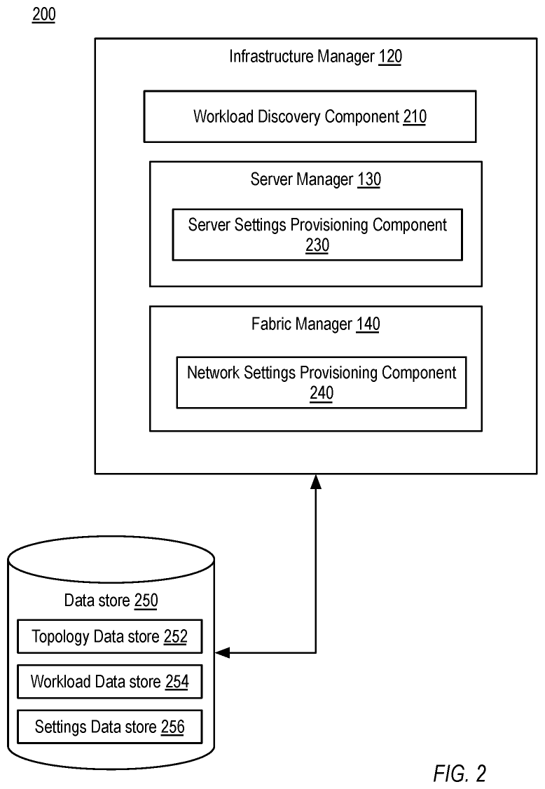

FIG. 2 illustrates a data center environment 200 including an infrastructure manager 120 providing for dynamic optimizations of server and network layers, according to some embodiments. In one embodiment, infrastructure manager 120 is the same as infrastructure manager 120 described with respect to FIG. 1. As shown in FIG. 2, infrastructure manager 120 of data center environment 200 includes a workload discovery component 210, server manager 130, and fabric manager 140. The example infrastructure manager 120 of FIG. 2 may include one or more elements, processes and/or devices in addition to, or instead of, those illustrated in FIG. 2, and/or may include more than one of any or all of the illustrated elements, processes, and devices.

In embodiments of the disclosure, the infrastructure manager 120 automatically and dynamically optimizes network and compute infrastructures properly for workloads running over the infrastructures. The infrastructure manager 120 may utilize its server manager 130 to provision a server instance, load an OS on the server instance, and configure the server instance for access to the network(s) it utilizes. From that point on, the infrastructure manager 120 can access data sent to/from the server instance via a managed network device and analyze the data provided by the network device. The network device itself can consolidate the information gathered from packet headers (e.g., the source, destination and urgency fields) during its layer 2 and 3 packet management actions at a certain interval, and the infrastructure manager 120 can request the data. The data that the infrastructure manager 120 receives from the network fabric component (e.g., network switch) for each server instance it manages can allow the infrastructure manager 120 to determine what workloads are running on each server, if not already known based on previous/existing server profile data.

In one embodiment, the workload discovery component 210 of the infrastructure manager 120 can analyze the network data running over the network fabric it manages in order to identify particular workloads running on the infrastructure. The traffic data may include network packets communicated over network fabric components (e.g., network switches managed by the infrastructure manager 120). Once sufficient traffic data is analyzed (e.g., a threshold number of data packets are analyzed), the infrastructure manager 120 can identify the workload and cause one or more BIOS and/or network configuration settings to be optimized on both the server running the workload as well as the network fabric communicating the workload. The infrastructure manager 120 may utilize server setting provisioning component 230 and network settings provisioning component 240 of the server manager 130 and fabric manager 140, respectively, to cause the one or more BIOS and/or network configuration settings to be optimized, as discussed in further detail below.

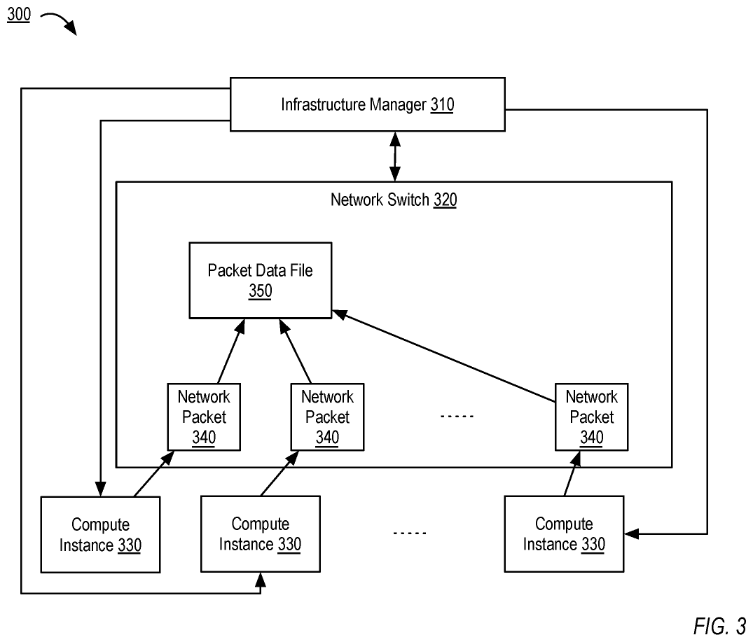

FIG. 3 is a block diagram of a data center environment 300 implementing dynamic optimizations of server and network layers according to some embodiments. Data center environment 300 depicts an example of how a workload running on a managed server instance could be identified using an infrastructure manager 310 (e.g., infrastructure manager 120 described with respect to FIGS. 1 and 2) in embodiments of the disclosure. The data center environment 300 of FIG. 3 includes an infrastructure manager 310 in communication with a network switch 320 and one or more compute instances 330. In one embodiment, the infrastructure manager 310 is the same as infrastructure manager 120 described with respect to FIGS. 1 and 2. Network switch 320 may include a network fabric component that is managed by infrastructure manager 310 and may include a chassis/frame switch and/or a ToR/EoR switch, for example. Compute instance 330 may include a virtualized or physical server instance provisioned and managed by the infrastructure manager 310.

In embodiments of the disclosure, one or more of the compute instances 330 sends or receives a network packet 340. The network switch 320 can save packet information corresponding to network packet 340 to a consolidated packet data file 350. The infrastructure manager 310 can retrieve the file 350 that includes packet header data of the network packets 340 communicated through the network switch 320 managed by the infrastructure manager 310. The infrastructure manager 310 then analyzes the retrieved file 350 and identifies a workload running on one or more compute instances 330 associated with the network packets. The workload may be identified based on, for example, values of source, destination, and/or urgency (QoS) fields in TCP/IP headers of the network packets 340. Based on the identified workload, the infrastructure manager 310 uses this data to cause both the server and network components to be programmed optimally for the identified workload, as discussed further below.

Referring back to FIG. 2, the infrastructure manager 120 may utilize server setting provisioning component 230 and network settings provisioning component 240 of the server manager 130 and fabric manager 140, respectively, to cause the one or more BIOS and/or network configuration settings to be optimized. For example, the server setting provisioning component 230 can make/implement recommendations and/or optimizations (e.g., updating BIOS setting) to its managed compute modules, such as the managed servers. The network settings provisioning component 240 can make/implement recommendations to managed network fabric (e.g., both chassis/frame and top of rack (ToR)/end of rack (EoR) switch setting updates).

In one implementation, the infrastructure manager 120 may reference a data store 250 communicably coupled to the infrastructure manager 120 to identify optimized profiles for particular identified workloads. For example, the data store 250 may include a topology data store 252, a workload data store 254, and/or a settings data store 256. The example data store 250 of FIG. 2 may include one or more data stores in addition to, or instead of, those illustrated in FIG. 2, and/or may include more than one of any or all of the illustrated data stores.

The topology data store 252 may be utilized by infrastructure manager 120 to maintain and manage information regarding the server instances and/or network fabric components managed by the infrastructure manager 120. In one example, topology data store 252 may maintain a media access control (MAC) address table utilized by the infrastructure manager 120. In some embodiments, the MAC address tables may be stored on the managed network fabric components, such as on a network switch.

The workload data store 254 may store information pertaining to identifying characteristics of workloads, such as source and destination ports associated with workload, Quality of Service (QoS) parameters associated with workload, and so on.

The settings data store 256 may include server and/or network settings that are determined to be optimized for a particular identified workload. The server and/or network settings may include, but are not limited to, BIOS settings, bandwidth settings, and/or transfer speed settings corresponding to particular workloads, for example. Further details regarding server and/or network settings are provided further below.

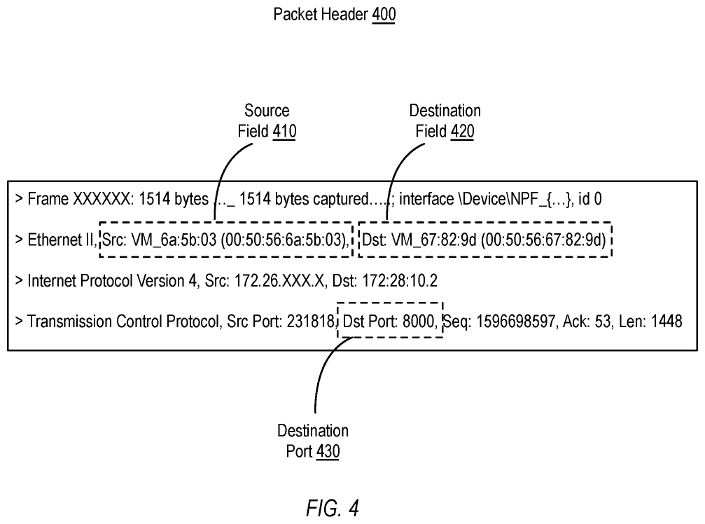

FIG. 4 is an example packet header 400 of a datacenter environment that can be analyzed for dynamic optimizations of server and network layers according to some embodiments. Packet header 400 illustrates one example implementation of a packet header that may be analyzed by embodiments of the disclosure, and is not intended to be limiting to the disclosure.

In one example, a network packet having packet header 400 passes over a managed network switch of an infrastructure manager (such as infrastructure manager 120 described with respect to FIGS. 1 and 2). In one example, packet header 400 includes, among other fields, a source field 410, a destination field 420, and a destination port 430. As shown in FIG. 4, the network packet having packet header 400 may, for example, pass between two VMware® cloud computing and virtualization software hosts within the VMware® reserved MAC address range including the addresses of 00:05:56:6a:5b:03 and 00:05:56:67:82:9d. The destination port 430 is shown as being defined as destination port 8000. In one example, destination port 8000 is conventionally known as the port used for VMware® vMotion® component that allows for live migration of a running virtual machine's (VM) file system from one storage system to another.

With reference to FIG. 2 and with respect to the example packet header 400 of FIG. 4, the infrastructure manager 120 may reference a MAC address table, such as one maintained in topology data store 252 of data store 250 or one maintained on a network switch managed by the infrastructure manager 120. By referencing the MAC address table(s), the infrastructure manager 120 can determine that the MAC address of 00:05:56:6a:5b:03 and 00:05:56:67:82:9d is on two different ports. The example MAC address table below illustrates such an example.

| | | | | |
|---|---|---|---|---|
| Vlan | Mac Address | Type | ConnectionId | Ports |

| | | | |
|---|---|---|---|
| 1 | 00:05:56:6a:5b:03 | Learnt | Twe 0/1/1 |
| 2 | 00:05:56:67:82:9d | Learnt | Twe 0/1/7 |

Based on the MAC address mapping to the port, the infrastructure manager 120 can determine which server under its management the identified workload is associated with. For example, the infrastructure manager 120 can access workload data store 254 to identify a workload associated with the particular port number and/or associated with any other identifying characteristics of packet header 400. In some embodiments, the infrastructure manager 120 can identify the workload, using for example workload data store 254, after analysis of a threshold of number of packet headers 400 of data packets. In some embodiments, the workload is identified after a threshold number of data packets including the particular value of an identifying characteristic are found. The threshold number of packets may be determined by a system administrator in one embodiment.

Once the workload has been identified, the infrastructure manager 120 can identify optimal settings for the identified workload for the corresponding server. For example, the infrastructure manager 120 can identify BIOS settings corresponding to the workload and maintained in settings data store 256. In embodiments of the disclosure, the infrastructure manager 120 can also cause the server to be tuned properly for that workload using the identified settings. For example, for Hewlett Packet Enterprises® Gen10 servers, the infrastructure manager 120 can cause the following settings to be set to maximize the performance, full functionality, and return on investment (ROI) of a server running an identified VMware® workload:

SR-IOV->enabled

VT-D->enabled

VT-x->enabled

Power Regulator->Static High Performance

Minimum Processor Idle Power Core C-state->No C-states

Minimum Processor Idle Power Package C-state->No C-states

Energy Performance BIAS->Max Performance

Collaborative Power Control->Disabled

Intel® DMI Link Frequency->Auto

Intel® Turbo Boost Technology->Enabled

NUMA Group Size Optimization->Clustered

UPI Link Power Management->Disabled

Sub-NUMA Clustering->Enabled

Energy-Efficient Turbo->Disabled

Uncore Frequency Shifting->Max

Channel Interleaving->Enabled

If any of these settings are not set, the infrastructure manager 120 can automatically set them and/or or prompt the user (e.g., administrator) to set them upon a next reboot. Building upon the above example, at the network layer, there are several items that the infrastructure manager 120 can implement to optimize traffic flow between servers communicating to each other based on an identified workload. In one example, the infrastructure manager 120 can set a maximum transmission unit (MTU) size on managed network fabric components. For example, the infrastructure manager 120 can set the MTU size to 9000 or above for vMotion® traffic to optimize the bandwidth and transfer speeds between hosts. The infrastructure manager 120 can cause the MTU size to be set properly on the ports that the switches of the network fabric are connected to. In some embodiments, the infrastructure manager 120 can cause priority to be given to particular traffic, such as vMotion® traffic in the above example, over regular Ethernet traffic. This may be enabled via QoS policies. The infrastructure manager 120 may also perform similar actions with other types of traffic, such as for storage, where latency should be kept to a minimum across a network fabric for proper operation.

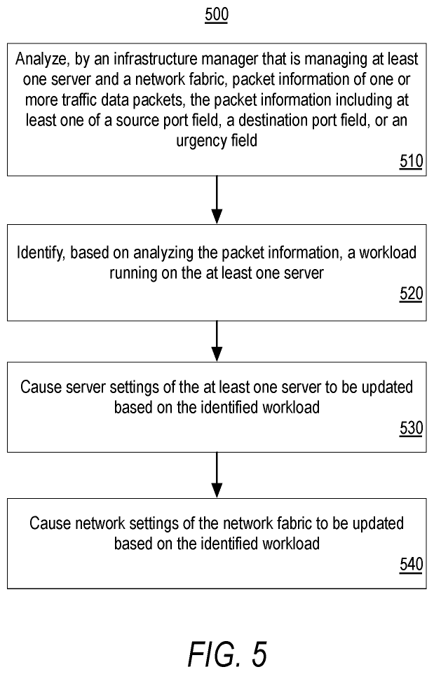

FIG. 5 is a flow chart to illustrate a process 500 for dynamic optimizations of server and network layers of datacenter environments in some embodiments. Method 500 may be performed by processing logic that may comprise hardware (e.g., circuitry, dedicated logic, programmable logic, etc.), software (such as instructions run on a processing device), or a combination thereof. In one embodiment, the process 500 may be performed by infrastructure manager 120 described with respect to FIGS. 1 and 2. In some embodiments, a process 500 to provide for dynamic optimizations of server and network layers of datacenter environments includes the following:

At block 510, a processing device, such as one executing an infrastructure manager that is managing at least one server and a network fabric, may analyze packet information of one or more traffic data packets. In one embodiment, the traffic information includes, at least, a source port field, a destination port field, and/or an urgency field. At block 520, the processing device may identify, based on analyzing the packet information, a workload running on the at least one server. In some embodiments, data associated with the identified workload is communicated over the network fabric managed by the infrastructure manager.

At block 530, the processing device may cause server settings of the at least server to be updated based on the identified workload. In one embodiment, the server settings include BIOS settings of the at least one server that are optimized for the particular identified workload. At block 540, the processing device may cause network settings of the network fabric to be updated based on the identified workload. In one embodiment, the network settings of the network fabric include bandwidth and/or transfer speed settings of one or more network devices of the network fabric that are optimized for the particular identified workload.

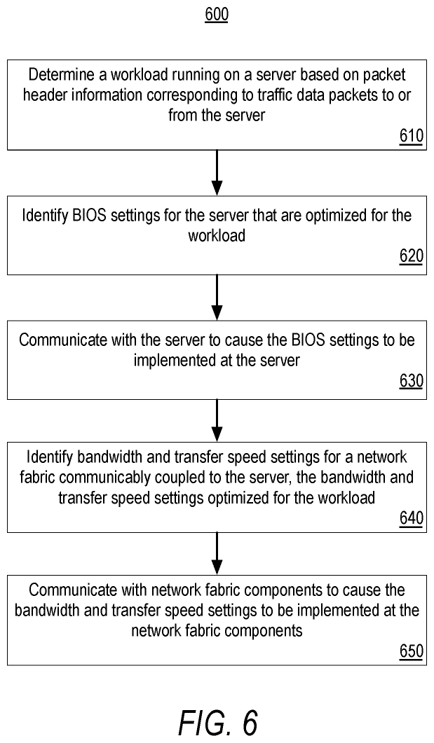

FIG. 6 is a flow chart to illustrate another process 600 for dynamic optimizations of server and network layers of datacenter environments in some embodiments. Method 600 may be performed by processing logic that may comprise hardware (e.g., circuitry, dedicated logic, programmable logic, etc.), software (such as instructions run on a processing device), or a combination thereof. In one embodiment, the process 600 may be performed by infrastructure manager 120 described with respect to FIGS. 1 and 2. In some embodiments, a process 600 to provide for dynamic optimizations of server and network layers of datacenter environments includes the following:

At block 610, a processing device, such as one executing an infrastructure manager that is managing at least one server and a network fabric, may determine a workload running on a server based on packet header information corresponding to traffic data packets communicated to or from the server. In one embodiment, a threshold number of traffic data packets is analyzed prior to identification of the workload. At block 620, the processing device may identify BIOS settings for the server that are optimized for the determined workload. At block 630, the processing device may communicate with the server to cause the BIOS settings to be implemented at the server. In one embodiment, the BIOS settings may be directly implemented by an infrastructure manager and/or the infrastructure manager may prompt an administrator to implement the BIOS settings.

At block 640, the processing device may identify bandwidth and transfer speed settings for a network fabric that is communicably coupled to the server. In one embodiment, the identified bandwidth and transfer speed settings are optimized for the determined workload. At block 650, the processing device may communicate with components of the network fabric to cause the bandwidth and transfer speed settings to be implemented at the components of the network fabric. In one embodiment, the bandwidth and transfer speed settings may be directly implemented by an infrastructure manager and/or the infrastructure manager may prompt an administrator to implement the bandwidth and transfer speed settings.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

The following clauses and/or examples pertain to further embodiments or examples. Specifics in the examples may be applied anywhere in one or more embodiments. The various features of the different embodiments or examples may be variously combined with certain features included and others excluded to suit a variety of different applications. Examples may include subject matter such as a method, means for performing acts of the method, at least one machine-readable medium (or machine-readable storage medium), such as a non-transitory machine-readable medium or a non-transitory machine-readable storage medium, including instructions that, when performed by a machine, cause the machine to perform acts of the method, or of an apparatus or system for facilitating operations according to embodiments and examples described herein.

In some embodiments, an apparatus includes a processor; and firmware executable by the processor, the firmware including infrastructure manager code to provide an infrastructure manager, wherein the infrastructure manager is to manage at least one server and a network fabric and is to: analyze packet information of one or more traffic data packets communicated by the at least one server over the network fabric, the packet information comprising at least one of a source port field, a destination port field, or an urgency field; identify, based on analyzing the packet information, a workload running on the at least one server; cause server settings of the at least one server to be updated based on the identified workload; and cause network settings of the network fabric to be updated based on the identified workload.

In some embodiments, one or more non-transitory computer-readable storage mediums have stored thereon executable computer program instructions that, when executed by one or more processors, cause the one or more processors to perform operations including analyzing, by the hardware processor executing an infrastructure manager managing at least one server and a network fabric, packet information of one or more traffic data packets communicated by the at least one server over the network fabric, the packet information comprising at least one of a source port field, a destination port field, or an urgency field; identifying, based on analyzing the packet information, a workload running on the at least one server; causing server settings of the at least one server to be updated based on the identified workload; and causing network settings of the network fabric to be updated based on the identified workload.

In some embodiments, method for dynamic optimizations of server and network layers of datacenter environments includes analyzing, by the hardware processor executing an infrastructure manager managing at least one server and a network fabric, packet information of one or more traffic data packets communicated by the at least one server over the network fabric, the packet information comprising at least one of a source port field, a destination port field, or an urgency field; identifying, based on analyzing the packet information, a workload running on the at least one server; causing server settings of the at least one server to be updated based on the identified workload; and causing network settings of the network fabric to be updated based on the identified workload.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer. In some embodiments, a non-transitory computer-readable storage medium has stored thereon data representing sequences of instructions that, when executed by a processor, cause the processor to perform certain operations.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic does not have to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of example embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments utilize more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

1. A non-transitory machine-readable storage medium encoded with instructions executable by a hardware processor of a computing component of a device, the non-transitory machine-readable storage medium comprising instructions to cause the hardware processor to:
analyzing, by the hardware processor executing an infrastructure manager managing at least one server and a network fabric, packet information of one or more traffic data packets communicated by the at least one server over the network fabric, the packet information comprising at least one of a source port field, a destination port field, or an urgency field;
identifying, based on analyzing the packet information, a workload running on the at least one server;
identifying an optimized profile for the workload identified as running on the at least one server;
causing server settings of the at least one server to be updated in accordance with the optimized profile, wherein the server settings comprise at least Basic Input/Output System (BIOS) settings of the at least one server; and
causing network settings of the network fabric to be updated in accordance with the optimized profile, wherein the network settings comprise at least one of chassis network switch settings or rack switch settings.

2. The non-transitory machine-readable storage medium of claim 1, wherein the workload is identified based on one or more values of the source port field, the destination port field, or the urgency field.

3. The non-transitory machine-readable storage medium of claim 1, wherein the workload is identified based on analyzing at least a threshold number of the one or more traffic data packets.

4. The non-transitory machine-readable storage medium of claim 1, wherein the infrastructure manager accesses a workload data store to identify the workload based on the packet information.

5. (canceled)

6. The non-transitory machine-readable storage medium of claim 1, wherein causing the server settings to be updated comprises executing, by the infrastructure manager, instructions to update the server settings at the at least one server.

7. The non-transitory machine-readable storage medium of claim 1, wherein causing the server settings to be updated comprises notifying a user that the server settings can be updated.

8. The non-transitory machine-readable storage medium of claim 1, wherein causing the network settings to be updated comprises executing, by the infrastructure manager, instructions to update the network settings at one or more network fabric components of the network fabric, wherein the one or more network fabric components comprises a network switch.

9. The non-transitory machine-readable storage medium of claim 1, wherein causing the network settings to be updated comprises notifying a user that the network settings can be updated.

10. The non-transitory machine-readable storage medium of claim 1, wherein the network settings comprise at least one of bandwidth settings or transfer speed settings of the network fabric.

11. A method comprising:
analyzing, by a hardware processor executing an infrastructure manager managing at least one server and a network fabric, packet information of one or more traffic data packets communicated by the at least one server over the network fabric, the packet information comprising at least one of a source port field, a destination port field, or an urgency field;
identifying, based on analyzing the packet information, a workload running on the at least one server;
identifying an optimized profile for the workload identified as running on the at least one server;
causing server settings of the at least one server to be updated in accordance with the optimized profile, wherein the server settings comprise at least Basic Input/Output System (BIOS) settings of the at least one server; and
causing network settings of the network fabric to be updated in accordance with the optimized profile, wherein the network settings comprise at least one of chassis network switch settings or rack switch settings.

12. The method of claim 11, wherein the workload is identified based on one or more values of the source port field, the destination port field, or the urgency field.

13. The method of claim 11, wherein the workload is identified based on analyzing at least a threshold number of the one or more traffic data packets.

14. The method of claim 11, wherein the infrastructure manager accesses a workload data store to identify the workload based on the packet information.

15. (canceled)

16. The method of claim 11, wherein the network settings comprise at least one of bandwidth settings or transfer speed settings of the network fabric.

17. An apparatus comprising:
a processor; and
firmware executable by the processor, the firmware including infrastructure manager code to provide an infrastructure manager, wherein the infrastructure manager is to manage at least one server and a network fabric and is to:
analyze packet information of one or more traffic data packets communicated by the at least one server over the network fabric, the packet information comprising at least one of a source port field, a destination port field, or an urgency field;
identify, based on analyzing the packet information, a workload running on the at least one server;
identify an optimized profile for the workload identified as running on the at least one server;
cause server settings of the at least one server to be updated in accordance with the optimized profile, wherein the server settings comprise at least Basic Input/Output System (BIOS) settings of the at least one server; and
cause network settings of the network fabric to be updated in accordance with the optimized profile, wherein the network settings comprise at least one of chassis network switch settings or rack switch settings.

18. The apparatus of claim 17, wherein the workload is identified based on one or more values of the source port field, the destination port field, or the urgency field.

19. (canceled)

20. The apparatus of claim 17, wherein the network settings comprise at least one of bandwidth settings or transfer speed settings of the network fabric.

21. The method of claim 11, wherein causing the network settings to be updated comprises executing, by the infrastructure manager, instructions to update the network settings at one or more network fabric components of the network fabric, wherein the one or more network fabric components comprises a network switch.

22. The apparatus of claim 17, wherein the infrastructure manager is further to cause the server settings to be updated comprises notifying a user that the server settings can be updated.

23. The apparatus of claim 17, wherein the infrastructure manager to cause the network settings to be updated further comprises the infrastructure manager to execute instructions to update the network settings at one or more network fabric components of the network fabric, wherein the one or more network fabric components comprises a network switch.
